(19) United States
(12) Patent Application Publication
(10) Pub. No.: US 2005/0016786 A1
(43) Pub. Date: Jan. 27, 2005

(54) Vehicle seat and control unit

(76) Inventors: Frank Mack, Stuttgart (DE); Thomas Lich, Schweikheim (DE)

Correspondence Address: Striker Striker & Stenby, 103 East Neck Road, Huntington, NY, 11743, US

(21) Appl. No.: 10/493,974

(22) PCT Filed: Feb. 13, 2003
(86) PCT No.: PCT/DE03/00425

(30) Foreign Application Priority Data
May 25, 2002 (DE) 102 23 365.9

(51) Int. Cl. B60R 21/00

(52) U.S. Cl. 180/271

(57) ABSTRACT

A vehicle seat with a sensor and a control unit with a sensor are proposed, which serve to make it possible to identify a pregnant person on a vehicle seat. Preferably, a piezoelectric sensor is used for this purpose. The piezoelectric sensor is advantageously embodied as a cable. As an integral transformation for analyzing the signal from the sensor, the Fourier transform or the wavelet transform are preferably used. Restraint means can be triggered as a function of the identification of a pregnant person.

### PRIOR ART

The invention is based on a vehicle seat and a control unit having a sensor, as generically defined by the preambles to the independent claims.

### ADVANTAGES OF THE INVENTION

The vehicle seat of the invention having a sensor and the control unit of the invention having a sensor have the advantage that they are designed to make it possible to identify a pregnant person. This becomes possible in particular by means of an integral transformation of a signal from the sensor, which makes it possible to associate a respiratory event with a pulse and thus, since an unborn child does not breathe yet, discloses two measured pulses but only one respiration for a pregnant person. If twins or triplets are involved, the number of pulses increases accordingly, but only one respiratory event, namely that of the pregnant woman, can be measured. This makes it possible to trigger restraint means such as belt tighteners and air bags adaptively to assure optimal protection for a pregnant person so that optimal protection of the unborn child in the event of an accident is made possible as well.

By the provisions and refinements recited in the dependent claims, advantageous improvements to the vehicle seat recited in the independent claim and the control unit recited in the independent claim are possible.

It is especially advantageous that the sensor is embodied as a piezoelectric sensor, which is especially suitable for analyzing an oscillating behavior by way of the respiration and the pulses. It is especially advantageous if the piezoelectric sensor is embodied as a cable which is embedded in the seat cushion, and the cable can preferably be cast integrally in plastic. The signal of the piezoelectric sensor can also be used for weight classification and also purely as a sensor to detect whether the seat is occupied.

### DRAWING

Exemplary embodiments of the invention are shown in the drawing and will be described in further detail in the ensuing description.

Shown are

FIG. 1, a vehicle seat of the invention;

FIG. 2, a control unit of the invention, with a sensor;

FIG. 3, a block circuit diagram of the control unit of the invention with a sensor; and

FIG. 4, the signals which the processor picks up and outputs again.

### DESCRIPTION

With the introduction of front-seat passenger air bags, the necessity has arisen, for both safety and insurance reasons, of detecting a front passenger seat occupied by a person. In an accident, if the front passenger seat is unoccupied, no passenger needs to be protected, so in that case, deployment of the air bag should be averted. This saves unnecessary repair costs. So-called smart bags are now to be used, which in terms of their inflation behavior are to be designed adaptively to both persons and situations. In particular, situations in which inflating the air bag should be avoided when it would be disadvantageous to the passenger should be detected. This is especially true if there are children in the front seat, or if the person is too close to the dashboard. Pregnant persons are also a risk group of this kind.

The object of the invention is to detect a pregnant person so that she can then be optimally protected.

According to the invention, this is attained by providing that a sensor in the vehicle seat is designed so as to enable detecting detect a pregnant person. This is advantageously attained by means of a piezoelectric sensor with which analysis of incident frequencies resulting from respiratory events and heartbeats can be done. However, still other sensors that can pick up the oscillating behavior can also be used.

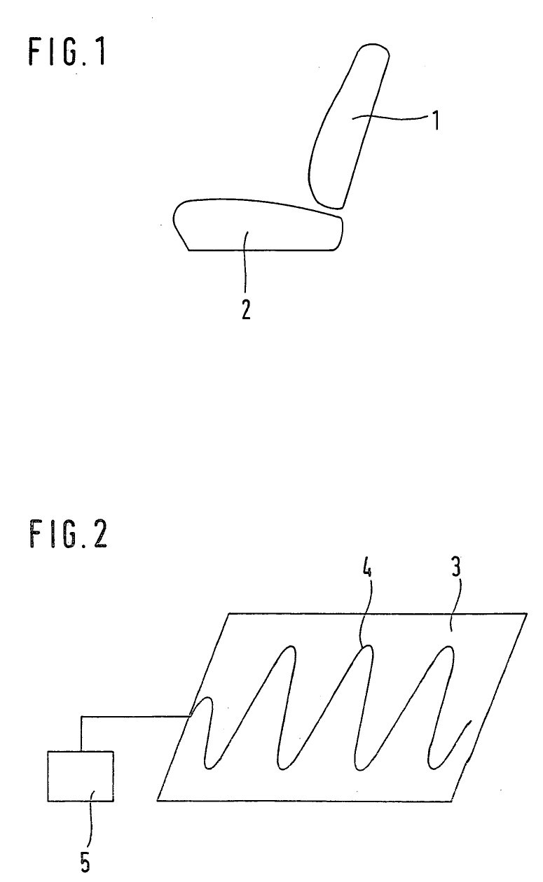

FIG. 1 shows a vehicle seat of the invention, which has a seat cushion 2 and a back cushion 1. The piezoelectric sensor can be built into either the seat cushion 2 or the backrest 1. It is also possible for the sensor to be built into both parts of the seat at the same time. This makes it possible to determine the plausibility of the outcome.

FIG. 2 schematically shows the piezoelectric sensor 4 in the form of a cable, which is embedded in a plastic 3. The piezoelectric sensor 4 is connected to a control unit 5 via a line. The control unit 5 has means for evaluating the signal from the piezoelectric sensor 4. In the control unit 5, there can also first be signal processing means such as amplifiers and filters for the signal from the piezoelectric sensor 4. As an alternative to the cable structure, still other geometric shapes can be used as the piezoelectric sensor 4. It is also possible to use a plurality of piezoelectric sensors. They then furnish their signals to the control unit 5. The control unit 5 then carries out the frequency analysis by means of an integral transformation of the signal from the piezoelectric sensor 4. The Fourier transform and the wavelet transform are suitable examples of integral transformation. Both are suitable for identifying certain events, such as respiration and heartbeats in the frequency ranges. The control unit 5 will digitize the processed signal by means of an analog-digital converter, or the processor may also be disposed in the sensor 4, and by means of a processor will then use this digital signal for frequency analysis, that is, the Fourier or wavelet analysis. The scanning frequency should be selected accordingly.

Using an algorithm, a pregnant person is detected from the fact that there are at least two pulse measurements but only one breath measurement. The pulse measurement of the pregnant woman is modulated by one breath measurement, while for the second, higher-frequency pulse measurement, the respiration is absent. From this it can be concluded that the latter situation is due to an unborn child.

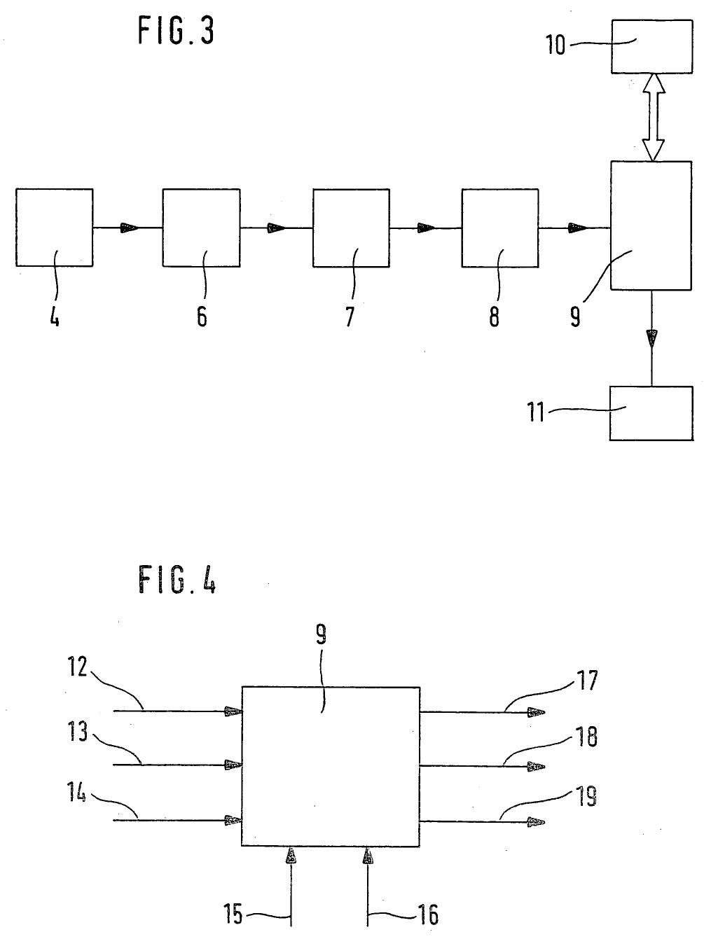

FIG. 3 illustrates this by means of a block diagram. A sensor 4 furnishes a signal to a signal processor 6, which here is a measurement amplifier. The amplified signal is then filtered by a filter 7, such as a bandpass filter. The thus-filtered signal is digitized by an analog-digital converter 8 so that it can then be analyzed by a processor 9 by means of a memory 10. For this purpose, as noted above, Fourier or wavelet analysis is employed. However, other integral transformations are also possible. If a pregnant woman is detected by the processor 9, then the restraint means 11 are triggered accordingly. In addition to detecting the pregnant woman, the processor 9 can also perform a classification of a passenger by weight and a determination as to whether the seat is occupied or not. As restraint means 11, belt tighteners, air bags, side air bags, and so forth are triggered.

FIG. 4 shows which signals can be introduced into the processor 9 so that the processor 9 will furnish the appropriate output signals. In the processor 9, the sensor signals 12, a speed 13, an rpm 14, signals from a vehicle bus 15, and the temperature 16 are furnished, so that from them the processor 9 determines whether a pregnant person is present, as indicated at 17; whether the seat is occupied, as indicated at 18; and what the weight class is if occupied, as indicated at 19. Thus when a piezoelectric sensor is used, it is possible to determine not only whether a pregnant person is occupying the seat but also whether anyone is occupying the seat at all, and what weight classification the person belongs to. As an alternative to a piezoelectric sensor, still other sensors that are capable of picking up such oscillations as the respiration rate and the pulse rate are suitable.

1. A vehicle seat having a sensor (4), wherein the sensor (4) is configured in such a way that a signal (12) from the sensor (4) makes it possible to identify a pregnant person.

2. The vehicle seat of claim 1, characterized in that the sensor (4) is embodied as a piezoelectric sensor.

3. The vehicle seat of claim 2, characterized in that the piezoelectric sensor (4) is embodied as a cable.

4. The vehicle seat of claim 3, characterized in that the cable (4) is embedded in the seat cushion.

5. The vehicle seat of claim 4, characterized in that the cable (4) is embedded in plastic.

6. A control unit having a sensor of one of claims 1 through 5, characterized in that the control unit (5) has a processor (9), which analyzes the signal (12) by means of an integral transformation in such a way that a pregnant person 5 can be identified by the identification of a respiratory event and at least two pulse frequencies.

7. The control unit of claim 6, characterized in that the control unit (5) can be connected to at least one restraint means (11), and the control unit triggers the at least one restraint means (11) as a function of the 5 identification of a pregnant person.

8. The control unit of claim 6 or 7, characterized in that the processor (9) uses either the Fourier transform or the wavelet transform as the integral transformation.
